(19) United States
(12) Patent Application Publication
(10) Pub. No.: US 2010/0048049 A1
(43) Pub. Date: Feb. 25, 2010

(54) ELECTRICAL CONNECTOR

(75) Inventor: Urbain Du Plessis, Mentone (AU)

Correspondence Address: Workman Nydegger;1000 Eagle Gate Tower, 60 East South Temple, Salt Lake City, UT, 84111, US

(73) Assignee: HELLA ASIA PACIFIC PTY LTD., Menton (AU)

(21) Appl. No.: 12/374,777

(22) PCT Filed: May 14, 2007
(86) PCT No.: PCT/AU07/00643

§ 371 Date: Sep. 28, 2009

(30) Foreign Application Priority Data
Jul. 26, 2006 (AU) 2006904060

(51) Int. Cl. H01R 13/62

(52) U.S. Cl. 439/157

(57) ABSTRACT

An electrical connector assembly comprising a pair of male connectors adapted to butt together, end to end, to complete an electrical connection, and a hollow barrel to accommodate the male connectors, the barrel having latch means to force the male connectors into abutting contact.

### DESCRIPTION OF THE INVENTION

A well known hazardous environment is the coal face of an underground coal mine. A vast amount of coal dust, which is very explosive when suspended in air and grit, is continually produced in the mining process. Although water is used to mitigate the dust and to lubricate the cutting process, this creates an abrasive, corrosive and electrically conductive slurry. A further compounding issue is the release of methane by the coal seam. This mix creates a very dirty and highly explosive environment.

Electrical power is used for lighting, communications and electronic control equipment. Whilst the supply voltage is usually kept low, the presence of even low powered devices places heavy demands on the electrical connector system.

The electrical connections need to be reliable and safe. There is also a need for these connections to simplify routine maintenance and, ensure fault finding is a simple and safe exercise. The presence of explosive gas and dust means that most conventional electrical test equipment such as multimeters and insulation testers cannot be used in this environment.

There are a number of problems that have been encountered with the use of existing connectors in dirty operating environments. Most electrical connectors are based on a pin being inserted into a spring loaded sleeve or receptacle. In typical mining hazardous operating environments, dirt cannot be removed effectively from inside a contact sleeve. Complete disassembly and cleaning of the connector in a clean environment outside the operating area is often required. In most applications, this is not a practical or cost effective solution. Furthermore, superficial cleaning with a rag or high pressure air available in the work environment will simply force dirt deeper into the contact sleeve. Grit between contact surfaces prevents or reduces effective contact between electrical conductors leading to unreliable operation and overheating of connectors and cable. This reduces connector service life significantly and is a major cause of intermittent operation and connector failures.

The electrical contact surface pressure is generally exerted by the contact sleeve itself or by a metal spring in direct contact with the electrical conductor. The nature of the assembly heats the conductor elements under normal conditions and greater heat is generated due to increased resistance when there is any compromised contact condition. This affects the contact pressure exerted by the spring and hence the effective contact resistance. These problems tend to reinforce each other and lead to premature failure.

The contact pressure also directly affects the connector insertion and removal force. The use of an excessive insertion force renders the connector difficult to use and also masks the essential mechanical feedback required to distinguish between a correctly mating assembly and a faulty assembly.

To prevent the interruption of the connection, twisting forces on cables are transferred to the connector bodies on most connectors. Protecting the connector pin in the sleeve does not eliminate the problem, it simply stores the energy in the cabling.

Detecting and identification of faulty or working cables in a live circuit is practically impossible in hazardous areas because conventional electrical testing tools are not allowed inside hazardous environments. This means that the cables must be removed from the area and tested in a safe environment. In most applications, this is not a practical or cost effective solution, and also masks many underlying problems encountered in actual operation.

Removing cables for testing requires shutting down all or part of the power to an area. Interrupting power to equipment such as lighting systems may be very hazardous and is always very costly because it requires interruption of production.

It is these issues that have brought about the present invention.

### SUMMARY OF THE INVENTION

According to one aspect of the present invention, there is provided an electrical connector assembly comprising a pair of male connectors adapted to butt together end to end to complete an electrical connection, a hollow barrel adapted to accommodate the male connectors, the barrel having latch means to force the male connectors into abutting contact.

Preferably, the latch means comprises a cam pivotally secured to the barrel whereby rotation of the cam draws the male connectors together into abutting contact.

The cam is preferably attached to an overcentre lever which is displaceable between an engaged or disengaged position. Preferably, a cam is pivotally secured on opposite sides of the barrel.

Preferably, the abutting faces of the male connectors are substantially flat. In a preferred embodiment the male connectors have concentric raised portions in abutting contact.

In a preferred embodiment, the electrical connector assembly includes an ultra low power light source operable to enable active/live circuits to be identified by sight. In a preferred embodiment, the system is designed to that illumination is visible through the connector. Preferably, different coloured light sources are used to identify different circuit voltages.

According to a further aspect of the invention an electrical connector comprises a hollow body with an electrical lead entering from one end to be coupled via a printed circuit board to a carrier that support electrical contacts, the carrier being positioned against an elastic support that urges the contacts to project outwardly of the body.

### DESCRIPTION OF THE DRAWINGS

An embodiment of the present invention will now be described by way of example only with reference to the accompanying drawings, in which:

FIG. 1 is a side elevational view of a male connector that forms part of an electrical connector assembly;

FIG. 2 is a cross sectional view of the male connector;

FIG. 3 is an end on view of the male connector;

FIG. 4 is a perspective view of a barrel connector in an open position;

FIG. 5 is a perspective view of the barrel connector in a closed position;

FIG. 6 is a side elevational view of two male connectors located in the barrel connector;

FIG. 7 is a cross sectional view of two male connectors housed within the barrel connector in an open configuration; and

FIG. 8 is a cross sectional view of two male connectors in the barrel connector in a locked position.

### DESCRIPTION OF THE PREFERRED EMBODIMENT

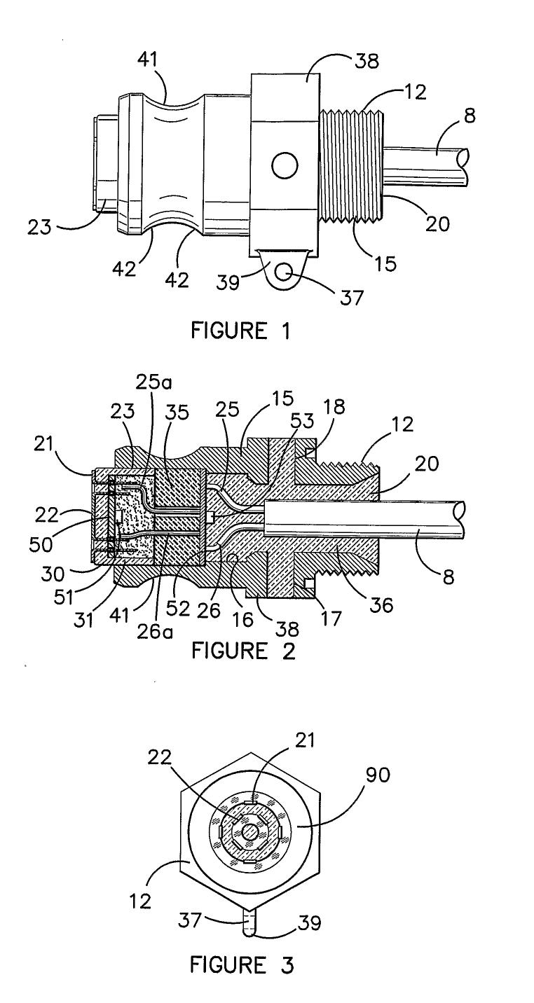

An electrical connector assembly 10 shown in FIGS. 6 to 8 comprises a female barrel connector 11 that houses two male electrical connectors 12, 13. FIGS. 1 to 3 show details of the male electrical connectors 12, 13.

The male connector 12 or 13 shown in FIGS. 1 to 3 comprises a connector body 15 that is substantially of circular cross section having a hollow throughway 16 that includes two radial viewing ports 17, 18. An electrical cable 8 with insulated connectors 25, 26, is inserted into one end 20 of the connector and is coupled to electrical contact surfaces 21, 22 that project from the other end 23 of the connector body 15. In this example the electrical contact surfaces 21, 22 are in the form of concentric brass rings, the outer ring 21 being the negative contact and the inner ring 22 providing the positive contact in a low voltage DC connector. The electrical contact surfaces 21, 22 are housed in a transparent plastics carrier 30 which is a sliding fit within the end 23 of the throughway 16 of the connector body 15. The carrier 30 has a rearwardly extending ring 31 that engages an elastic support 35. The ring 31 is filled with translucent encapsulant 32. The carrier 30 and support 35 allow about 2 to 3 mm of resilient axial movement of the contact surfaces 21, 22 relative to the body 15. The remainder of the interior of the connector body 15 is filled with a transparent plastics encapsulant 36.

An LED 50 associated with a first miniature printed circuit board 51 is coupled to the negative and positive contact surfaces 21, 22 behind the carrier 30 to provide a visual indication of current flow that is visible from the exterior of the connector through the transparent contact carrier 30, transparent encapsulant 36 and radial viewing ports 17, 18 in the connector body 15. A second printed circuit board 52 and LED 53 is also positioned behind the support ring 35 and connectors 25a and 26a couple the second circuit board 52 to the first circuit board 51.

As shown in FIGS. 1 to 3, an enlarged portion 38 of the connector body has on its exterior a lug 39 with a small aperture 37 to allow a lanyard and protective cover to be is secured to the connector (not shown).

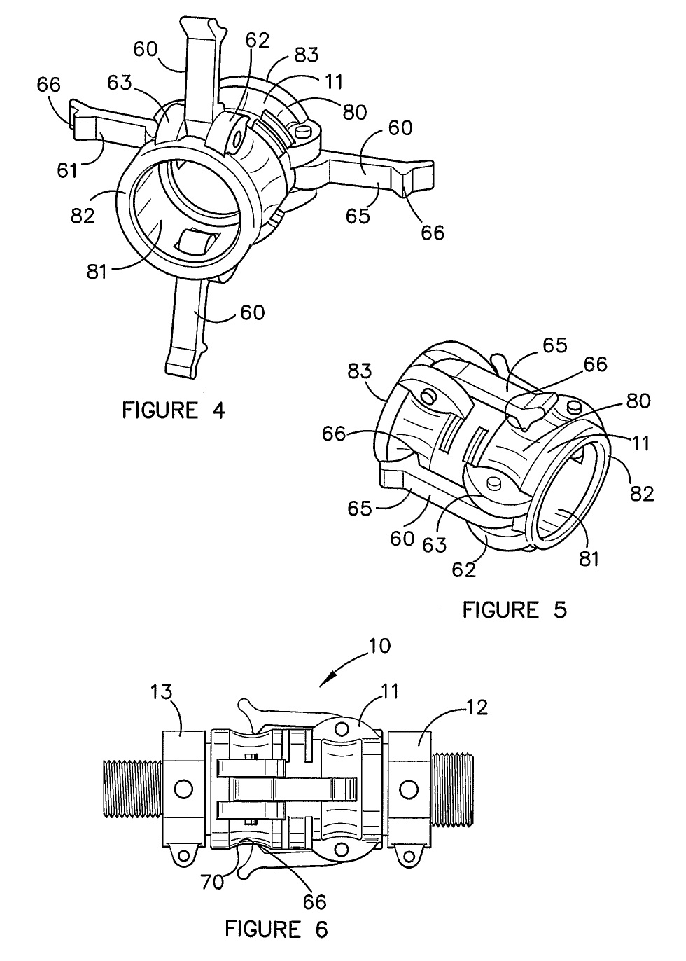

The male connector 12 shown in FIGS. 1 to 3 is arranged to abut an identical male connector 13 whereby the contact surfaces are in abutting concentric contact. To hold the male connectors 12, 13 in abutting contact and to ensure a positive electrical connection, a female barrel connector 11 shown in FIGS. 4 and 5 is used, to not only house the male connectors 12, 13, but to pull the male connectors into firm abutting contact within the barrel connector 11. Because the barrel connector 11 comprises, as shown in FIGS. 4 and 5, an elongate circular body 80 defining a hollow throughway 81. Diametrically opposed at each end 82, 83 of the body are a pair of cam locks 60, 61 that are pivotally secured to lugs 62, 63 on the exterior of the body 80. Each cam lock 60, 61 comprises a cam 64 with a projecting arm 65. The cam 64 is pivotally secured to the lug 62 and the body of the barrel connector has an aperture 68 in its wall surface through which the cam 64 can extend as shown in FIG. 4. A pair of cam locks are positioned at opposite ends of the barrel connector, diametrically opposed as shown in FIG. 4. FIG. 4 also shows the cam locks in an open configuration whereby the arms 65 are pivoted to extend radially outwardly of the barrel connector 11.

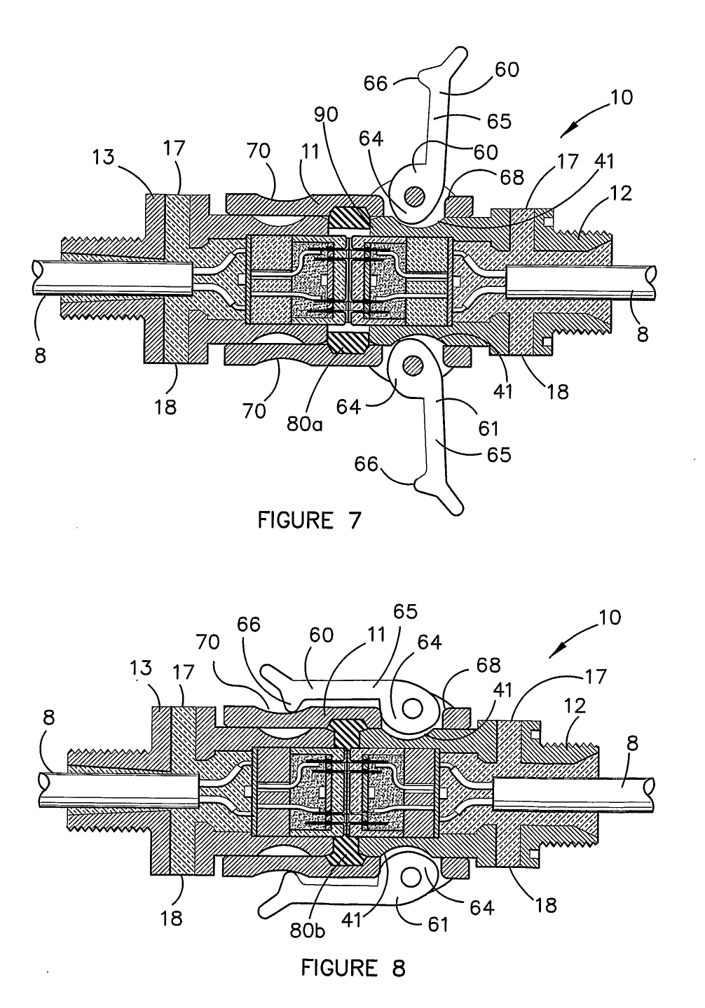

As shown in FIG. 6, each arm 65 terminates in a heel 66 at the opposite end that is arranged to sit within a recess 70 in the exterior of the body of the barrel connector 11. The cam locks 60, 61 are also secured to the barrel connector 11 so that movement to the locked position in FIG. 8 causes the cam 64 to move to an overcentre position with the heel 66 of the arm engaging the recess 70 in the barrel connector body, thus ensuring the cam locks remain in the locked position. The exterior of each male connector includes an annular recess 41 with a curved wall 42 into which the cam 64 can locate. When the male connectors are first inserted into the barrel connector 11 as shown in FIG. 7 with the cam locks 60, 61 in the open position, each cam 64 is simply a loose fit within the recess 41. However, when the cam lock is turned to the closed position shown in FIG. 8, the engagement of the cam 64 with the curved wall 42 on the male connector 12 pushes the male connector 12 forwardly to lock both connectors 12, 13 firmly in engagement within the barrel 11. As can be seen from FIGS. 7 and 8, there is a 1.9 mm movement of the connector into the barrel on both sides. By closing off both pairs of cam locks 61, 62, both male connectors are pressed into firm engagement and held locked within the barrel connector 11. The resilience of the connector plates on both connectors 12, 13 ensures positive face to face annular engagement of the contact surfaces.

The connector body 11 of each male connector 12, 13 is preferably manufactured from metal or hard engineered plastics. The electrical contact support is manufactured from a closed cell foam or similar compressible plastics with a very low memory. The material will be translucent or opaque. The contact carrier 30 is manufactured from hard, clear or translucent plastics which is electrically insulating to allow light to transmit through whilst providing a dimensionally stable base for the contact surfaces 21, 22. The contact surface rings 21, 22 will be typically manufactured from copper with a gold plated surface or from a single noble material like Rhodium. The small printed circuit boards 51, 52 are used to assembly the contacts and carry LEDs 50, 53 that generate a light source for each contact whenever there is power available at the connector for each conductor. The second printed circuit 52 board and LED 53 is used behind the opaque plastic contact support to generate light that is visible through the radial viewing ports 17, 18 in the connector body 15. The translucent encapsulating material 36 in the body of the connector allows light to escape through the viewing ports 17, 18, whilst at the same time, maintaining the integrity of the assembled parts. This is a further safety feature particularly when this equipment is used in especially hazardous environments.

When the cam locks 60, 61 are applied to the barrel, each male connector is forced 3.8 mm beyond the point where the contact faces meet. The elastic contact support 35 is compressed when the barrel is locked generating contact pressure. A self balancing action of contact pressure across the contact faces ensures that they are optimally aligned with each other. Due to the reaction of the contact pressure of the over centre location of the locking arms, the system is stable and vibration proof. Because all the contact areas are uninterrupted and smooth, the two connectors will safely rotate relative to each other as soon as a turning moment greater than the contact pressure is applied to the body. This action does not diminish or effect the contact pressure and integrity of the electrical connection and does not place the cable or connector under a stored torque.

The barrel connector 11 also contains a flexible seal 80 in an annular groove 85. The seal is preferably manufactured from a suitable flexible compound with low memory. The seal 80a is shown in a relaxed state in FIG. 7. When the connector assembly is locked as shown in FIG. 8 the seal 80a is compressed between the two male connectors 12 and 13, sealing against their face surfaces 90. In this locked state the electrical connectors are completely sealed from their operating environment preventing any liquid, dust or other unwanted matter to enter the assembly.

The flat faced connectors allow no space for dirt or liquid to settle and can be simply cleaned in a dirty environment. The elastic mounting of the contact assembly allows two contact surfaces to continuously align. Furthermore, the elastic mounting is remote from the electrical contents allowing contact forces to be calibrated and maintained independently of contact temperatures. The concentric contact surfaces provide a low resistance contact surface that remains cool. The concentric contact surfaces allow unlimited twisting movement between the contacts with no effect on electrical contact efficiency. The concentric contact construction enables the continuation of induction screens across the connector.

The use of small LEDs to provide self illuminating connectors, provides an ultra low power light sources compliant to the hazardous area to satisfy regulations and enables active/live circuits to be identified by sight without use of testing tools. By designing the connector systems to that the illumination is visible when the connector is open through the connector face and through the radial ports in the connector body when coupled, allows active circuit to be identified and traced in complete safety across several operating connections with no need to interrupt the power. The use of different coloured light sources provides identification in different circuit voltages.

The use of a single sex or two male connectors eliminates all sockets or sleeves that can collect dirt. By locking two male connectors face to face using the double barrel, the barrel is completely open and loose and can be cleaned with a blast or air or wiped with a rag. The barrel provides all the locking force and is completely independent from the electrical function and circuit. This arrangement separates the electrical contact pressure from the insertion force function, allowing much larger contact pressures to be generated while providing very low insertion forces.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An electrical connector assembly comprising a pair of male connectors adapted to butt together, end to end, to complete an electrical connection, and a hollow barrel to accommodate the male connectors, the barrel having latch means to force the male connectors into abutting contact.

2. The electrical connector assembly according to claim 1 wherein the latch means comprises cams pivotally secured to the barrel to engage the male connectors whereby rotation of the cams draw the male connectors together into abutting contact.

3. The electrical connector assembly according to claim 2 wherein each cam is attached to an over-centre lever which is displaceable between an engaged or disengaged position.

4. The electrical connector assembly according to claim 2 wherein a pair of cams are pivotally secured on opposite sides at either end of the barrel.

5. The electrical connector assembly according to claim 1 wherein each male connector comprises a hollow body with an electrical lead entering from one end to be coupled to a carrier that supports electrical contacts that project from the other end of the body.

6. The electrical connector assembly according to claim 5 wherein the connector includes resilient means to urge the contacts to project axially out of the body.

7. The electrical connector assembly according to claim 6 wherein the resilient means comprises an elastic contact support positioned behind the carrier.

8. The electrical connector assembly according to claim 5 wherein the contacts are concentric rings projecting forwardly from a substantially flat outer face of the carrier.

9. The electrical connector assembly according to claim 5 wherein the male connector incorporates a printed circuit board to which conductors of the electrical lead are attached, the printed circuit board including an ultra low powered light source.

10. The electrical connector assembly according to claim 9 wherein a first printed circuit board is attached to the rear of the carrier.

11. The electrical connector assembly according to claim 7 wherein a second printed circuit board is attached behind the elastic contact support

12. The electrical connector assembly according to claim 5 wherein the hollow body has at least one hole facilitating viewing access to the interior.

13. The electrical connector assembly according to claim 5 wherein the carrier is translucent.

14. The electrical connector assembly according to claim 5 wherein an encapsulant holds the electrical lead within the hollow body.

15. The electrical connector assembly according to claim 14 wherein the encapsulant is translucent.

16. The electrical connector assembly according to claim 9 wherein different coloured light sources are used to identify different circuit voltages.

17. An electrical connector comprising a hollow body with an electrical lead entering from one end to be coupled to a carrier that supports electrical contacts that project from the other end of the body, the carrier being positioned against an elastic support that urges the contacts to project outwardly of the body.

18. The electrical connector according to claim 17 wherein the contacts are concentric rings on the face of the carrier.

19. The electrical connector according to claim 17 wherein a light source is mounted on the printed circuit board.

20. The electrical connector according to claim 17 wherein any one or more of the body, carrier and support are translucent.
